(19) United States
(12) Patent Application Publication
(10) Pub. No.: US 2003/0030669 A1
(43) Pub. Date: Feb. 13, 2003

(54) Display apparatus, capturing apparatus, image searching apparatus and program

(75) Inventor: Shuji Ono, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/170,371

(22) Filed: Jun. 14, 2002

(30) Foreign Application Priority Data
Jul. 26, 2001 (JP) JP 2001-226863

(51) Int. Cl. G06F 7/00

(52) U.S. Cl. 345/747; 707/2

(57) ABSTRACT

A display apparatus for displaying an image, includes: a display unit for displaying the image; and an importance calculation unit for calculating an importance factor indicative of importance of the image based on a history in which the display unit displayed the image.

This patent application claims priority from a Japanese patent application No. 2001-226863 filed on Jul. 26, 2001, the contents of which are incorporated herein by reference.

### BACKGROUND OF THE INVENTION

1. Field of the Invention

The present invention relates to a display apparatus, a capturing apparatus, an image searching apparatus and a program. More particularly, the present invention relates to a display apparatus, a capturing apparatus, an image searching apparatus and a program which can reflect the preference of a person who captured an image or views the image.

2. Description of the Related Art

There has been conventionally known, as a method for searching an image, a searching method in which a keyword is provided to each of images and a desired image is searched by the keywords, a method in which the degree of similarity between stored images and a given image is determined based on features of the images and stored images similar to the given image are then searched, and the like. In the former method, the desired image is searched based on a selected keyword in an image database that stores a plurality of images and the keywords provided to the respective images to correspond to each other, for example. In the latter method, the given image which is drawn by a user is employed for searching the images similar to the given image searched, as disclosed in Japanese Patent Application Laying-Open No. 2000-76270, for example.

However, in the former method, the enormous amount of time and effort for applying the keyword to each image is required. Also, in the searching operation for the desired image, it is difficult to give an appropriate keyword. Moreover, in the latter method, the time and effort is necessary because the user had to prepare the image used for the search. In addition, in a case of searching the desired image by the conventional searching method, it is likely to detect a lot of unnecessary images. That is, since the image, that is not important to the user, is also detected, the user had to perform further search of the image.

### SUMMARY OF THE INVENTION

Therefore, it is an object of the present invention to provide a display apparatus, a capturing apparatus, an image searching apparatus and a program, which are capable of overcoming the above drawbacks accompanying the conventional art. The above and other objects can be achieved by combinations described in the independent claims. The dependent claims define further advantageous and exemplary combinations of the present invention.

According to the first aspect of the present invention, a display apparatus for displaying an image, comprises: a display unit operable to display the image; and an importance calculation unit operable to calculate an importance factor indicative of importance of the image based on a history in which the display unit displayed the image.

The importance calculation unit may calculate the importance factor of the image based on a number of times the display unit displayed the image.

The importance calculation unit may calculate the importance factor of the image based on a time period in which the display unit displayed the image.

The display unit may include an enlarging unit operable to enlarge all or a part of the image when displaying the image, and the importance calculation unit may calculate the importance factor of the image based on whether or not the display unit enlarged the image when displaying the image.

The importance calculation unit may calculate the importance factor of the image further based on a subject in the image.

The importance calculation unit may calculate the importance factor of the image based on whether or not a person is captured in the image.

The display apparatus may further comprise a subject detection unit operable to detect a predetermined subject, wherein the importance calculation unit calculates the importance factor of the image based on a result of detection by the subject detection unit whether or not the predetermined subject is captured.

The display apparatus may further comprise a storing unit operable to store a plurality of images and importance factors respectively calculated for the plurality of images by the importance calculation unit in such a manner that the plurality of images and the importance factors correspond to each other, wherein the display unit displays at least one of the plurality of images stored in the storing unit.

In a case where the display unit enlarged a part of the image when displaying the image, the storing unit may store the part of the image enlarged by the display unit to correspond to the image.

The display unit may display at least one of the plurality of image based on the importance factors.

The display unit may display the plurality of images in an order from an image of the highest importance factor.

The display apparatus may be connected to an image database storing a plurality of images via a network, and the display unit may display at least one of the plurality of images stored in the image database.

The display apparatus may further comprise a storing unit operable to store the image displayed by the display unit and the importance factor corresponding to the image.

The display apparatus may further comprise a storing unit operable to an identification signal of the image in the network, displayed by the display unit, and the importance factor corresponding to the image.

The display apparatus may further comprise an image searching apparatus operable to search a desired one of the plurality of images stored in the storing unit based on the importance factors stored by the storing unit.

The display apparatus may further comprise an image searching apparatus operable to search a desired one of the plurality of images stored in the image database based on the importance factors stored by the storing unit.

The storing unit may store the image searched by the image searching apparatus.

The image searching apparatus may receive a search condition for searching the desired image supplied thereto, and searches the desired image based on the search condition.

The image searching apparatus may search the desired image from images each having the importance factor greater than a predetermined value.

The image searching apparatus may search an image similar to the image, that has the importance factor greater than a predetermined value.

According to the second aspect of the present invention, a program, for use with a display apparatus, for making a display apparatus calculate importance of an image is provided. The program makes the display apparatus operate as: a display unit operable to display the image; and an importance calculation unit operable to calculate an importance factor indicative of the importance of the image based on a history in which the display unit displayed the image.

According to the third aspect of the present invention, a capturing apparatus for capturing an image, comprises: a capturing unit operable to capture the image of a subject; a time measuring unit operable to measure a capture-preparation time for capturing the image; and an importance calculation unit operable to calculate an importance factor indicative of importance of the image based on the capture-preparation time measured by the time measuring unit.

The capturing apparatus may further comprise a storing unit operable to store the importance factor calculated by the importance calculation unit to correspond to the image.

The capturing unit may have a zoom lens, and the time measuring unit may measure the capture-preparation time based on a driving time of the zoom lens during a capture of the image.

The time measuring unit may measure the capture-preparation time based on a time from a driving start of the zoom lens during the capture of the image to a time at which the capturing unit has captured the image.

The capturing unit may have a focus lens, and the time measuring unit may measure the capture-preparation time based on a driving time of the focus lens during a capture of the image.

The time measuring unit may measure the capture-preparation time based on a time from a driving start of the focus lens during the capture of the image to a time at which the capturing unit has captured the image.

The capturing apparatus may further comprise a release switch operable to control a capturing timing of the capturing unit, wherein the time measuring unit includes a determining unit operable to determine whether or not a user is in contact with the release switch, and measures the capture-preparation time based on a time during which the user is in contact with the release switch.

The time measuring unit may measure the capture-preparation time based on a time during which the user is in continuous contact with the release switch until the user presses the release switch.

The importance calculation unit may calculate the importance factor of the image further based on a subject in the image.

The importance calculation unit may calculate the importance factor of the image based on whether or not a person is captured in the image.

The capturing apparatus may further comprise a subject detection unit operable to detect a predetermined subject, wherein the importance calculation unit calculates the importance factor of the image based on whether or not the predetermined subject is captured in the image.

According to the fourth aspect of the present invention, a program, for use with a capturing apparatus, for making the capturing apparatus calculate importance of an image is provided. The program makes the capturing apparatus operate as: a capturing unit operable to capture the image of a subject; a time measuring unit operable to measure a capture-preparation time for capturing the image; and an importance calculation unit operable to calculate an importance factor indicative of the importance of the image based on the capture-preparation time measured by the time measuring unit.

According to the fifth aspect of the present invention, an image searching apparatus for searching a desired image from a plurality of images stored in an image database, comprises: an importance storing unit operable to store an importance factor indicative of importance of each of the images; and a searching unit operable to search the desired image in the image database based on the importance factor.

The importance storing unit may store the importance factor for each image based on a time-preparation time when the image is captured.

According to the sixth aspect of the present invention, a program, for use with an image searching apparatus, for making the image searching apparatus search a desired image from a plurality of images stored in an image database, is provided. The program makes the image searching apparatus operate as: an importance storing unit operable to store an importance factor of each image indicative of importance of the image; and a searching unit operable to search the desired image in the image database.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 is a block diagram schematically showing an exemplary structure of a display apparatus according to the present invention.

FIG. 2 is a block diagram schematically showing another exemplary structure of the display apparatus according to the present invention.

FIG. 3 is a block diagram schematically showing still another exemplary structure of the display apparatus according to the present invention.

FIG. 4 is a block diagram schematically showing an exemplary structure of a capturing apparatus according to the present invention.

FIG. 5 is a block diagram schematically showing an exemplary structure of the capturing apparatus according to the present invention.

FIG. 6 is a block diagram schematically showing an exemplary structure of an image searching apparatus according to the present invention.

FIG. 7 shows an exemplary hardware configuration of the image searching apparatus according to the present invention.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

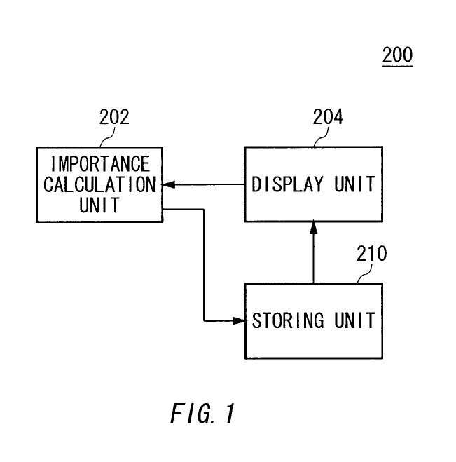

FIG. 1 is a block diagram schematically showing the structure of a display apparatus 200 according to the present invention. The display apparatus 200 includes a display unit 204, an importance calculation unit 202 and a storing unit 210.

In an example, the storing unit 210 stores a plurality of images and the display unit 204 displays the images stored in the storing unit 210. For example, the display unit 204 displays one of the images stored in the storing unit 210, that is specified by a user.

The importance calculation unit 202 calculates an importance factor indicative of the importance of each image based on a history in which the display unit 204 displayed that image. For example, the importance calculation unit 202 may calculate the importance factor for the image based on the number of the times the display unit 204 has displayed that image before. In other words, the importance calculation unit 202 may calculate the importance factor for each image while considering that the image that has been displayed by the display unit 204 more has a higher importance to the user.

Moreover, the importance calculation unit 202 may calculate the importance factor for each image based on the length of a time period during which the display unit 204 displays that image. In other words, the importance calculation unit 202 may calculate the importance factor for each image while considering that the image that is displayed for a longer time period has a higher importance to the user.

The storing unit 210 stores a plurality of images and the importance factors which the importance calculation unit 202 calculated for each of the images, in such a manner that each image and the importance factor therefor corresponds to each other. According to the display apparatus 200 in this example. The display unit 204 calculates the importance of the image to the user based on the history in which the display unit 204 has displayed that image before. For example, the importance of the image is calculated with preference of the user reflected thereon.

The display unit 204 may display the images stored in the storing unit 210 based on the importance factors stored in the storing unit 210. For example, the display unit 204 may display a plurality of images stored by the storing unit 210 in an order from the highest importance to the lowest importance. In this case, it is preferable that the display apparatus 200 has two display modes containing a normal display mode and a mode in which the images are displayed in the order from the image of the highest importance and include a unit for allowing the user to select one of these two modes. According to the display apparatus 200 of the present example, the images are displayed in the order from the image of the highest importance to the user.

Moreover, the display unit 204 may include a unit for enlarging an entire part of a particular part of the image when displaying that image. In this case, it is preferable that the importance calculation unit 202 calculates the importance factor for each image based on whether or not the display unit 204 has enlarged that image before when displaying it. Also, it is preferable that, in a case where the display unit 204 has ever enlarged a part of the image when displaying it, the storing unit 210 stores the enlarged part of the image so as to correspond to that image. According to the display apparatus 200 of the present example, the importance of the image on which the preference of the user or the like is more precisely reflected is calculated. In addition, according to the display apparatus 200 of the present example, it is possible to store and easily reproduce the part of the image, that is important to the user.

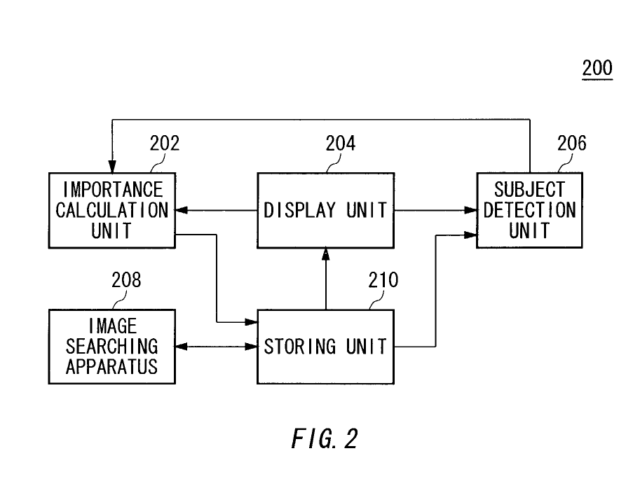

FIG. 2 is a block diagram schematically showing another exemplary structure of the display apparatus 200 according to the present invention. The display apparatus 200 includes the display unit 204, the importance calculation unit 202, the storing unit 210, an image searching apparatus 208 and a subject detection unit 206. In FIG. 2, the components labeled with the same reference numerals as those in FIG. 1 have the same or similar functions and structures as/to those described referring to FIG. 1.

According to the embodiment of the present invention shown in FIG. 2, the importance calculation unit 202 calculates the importance factor of each image based on the subject in that image. For example, the importance calculation unit 202 calculates the importance factor of the image based on whether or not a person, for example, is captured in that image. The subject detection unit 206 detects a predetermined subject from the image displayed by the display unit 204 or stored in the storing unit 210. As an example, a detection condition for detecting the predetermined subject is supplied to the subject detection unit 206.

For example, the subject detection unit 206 receives the detection condition regarding the shape, color, brightness of the subject or the like, supplied thereto. The importance calculation unit 202 calculates the importance factor of each image based on the result of the detection by the subject detection unit 206, whether or not the predetermined subject is captured. For example, the detection condition for detecting an important person to the user, such as the user, the family and friends of the user, a famous person and the like, is supplied to the subject detection unit 206, while the importance calculation unit 202 calculates the importance factor of the image based on whether or not such an important person is captured in that particular image.

The image searching apparatus 208 searches a desired image from the images in the storing unit 210 based on the importance factors stored in the storing unit 210. For example, the image searching apparatus 208 conducts a search for the image having the importance factor greater than a predetermined value from the images stored in the storing unit 210. Moreover, the image searching apparatus 208 searches out a predetermined number of images from the images in the storing unit 210 in an order from the image of the highest importance.

In addition, the image searching apparatus 208 receives a search condition for searching a desired image supplied thereto and search the image further based on the search condition. For example, the image searching apparatus 208 conducts a search for an image which satisfies the search condition, from the images stored in the storing unit 210 that have the importance factors greater than the predetermined value. Furthermore, the image searching apparatus 208 searches out the image which satisfies the search condition, from the predetermined number of the image stored in the storing unit 210, that are selected in the order from the image of the highest importance.

The image searching apparatus 208 receives a keyword for searching an image supplied thereto and searches the image based on the keyword. In this case, the storing unit 210 preferably stores therein the keyword corresponding to each image. Moreover, the image searching apparatus 208 receives an image supplied thereto and search an image similar to the received image. According to the display apparatus 200 of the present example, the image is searched out based on the importance factors of the images. Thus, it is possible to efficiently search the important and useful image to the user. In addition, the image searching apparatus 208 conducts a search for an image that is similar to the images having the importance factor or factors greater than a predetermined value, from the images stored in the storing unit 210. According to the image searching apparatus 200 of the present example, it is possible to easily search the image similar to the image important to the user.

The display unit 204 may display the image searched by the image searching unit 208. Moreover, the importance calculation unit 202 calculates, based on the history in which the display unit 204 has displayed the searched image before, a new importance factor for that image. According to the display apparatus 200 of the present example, the importance factor of the image is calculated out more precisely.

The importance calculation unit 202 described referring to FIGS. 1 and 2 uses the number of the times the display unit 204 has displayed the image before or the length of the time period in which the display unit 204 has displayed the image as the importance factor of that image. The storing unit 210 stores the number of the times the display unit 204 displayed the image or the length of the time period in which the display unit 204 displayed the image as the importance factor of that image. Moreover, the importance calculation unit 202 calculates, based on at least one of the number of the times the display unit 204 has displayed the image before, the length of the time period in which the display unit 204 has displayed the image, whether or not the display unit 204 has enlarged the image when displaying it and the subject of the image, the importance factor of that image. Furthermore, the importance calculation unit 202 calculates the importance factor of each image in such a manner that, when the displayed unit 204 does not display an image for a predetermined time period, the importance of that image is reduced.

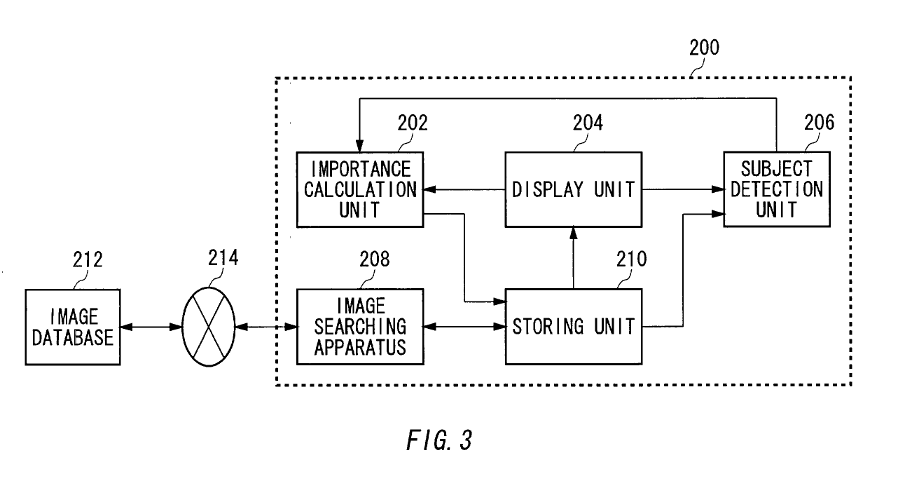

FIG. 3 is a block diagram schematically showing still another exemplary structure of the display apparatus 200 of the present invention. The display apparatus 200 in this example may have the same or similar functions and structure as/to those of the display apparatus 200 described referring to FIG. 2. The display apparatus 200 is connected via a network 214 to an image database 212 storing a plurality of images therein. For example, the display apparatus 200 connects to a plurality of image databases 212 via the Internet.

The display unit 204 displays the images stored in the image database 212. For example, the display unit 204 displays an image in the image database 212 specified by the user. The importance calculation unit 202 calculates the importance factor of the image stored in the image database 212, that is displayed by the display unit 204, in a similar manner to that of the importance calculation unit 202 described referring to FIG. 2.

The storing unit 210 stores therein the image displayed by the display unit 204 and the importance factor corresponding to that image. Moreover, the storing unit 210 stores an identification signal of the image in the network 214 that is displayed by the display unit 204 and the importance factor corresponding to that image. For example, the storing unit 210 stores an address of the image in the network 214 that is displayed by the display unit 204 and the importance corresponding to that image.

The image searching apparatus 208 conducts a search for a desired image from the images stored in a plurality of image databases 210 based on the importance factors stored in the storing unit 210, like the image searching apparatus 208 described referring to FIG. 2. The image searching apparatus 208 may receive a search condition for searching the desired image, supplied thereto, like the image searching apparatus 208 described referring to FIG. 2. The display unit 204 may display the image searched by the image searching apparatus 208. The storing unit 210 may store the image searched by the image searching apparatus 208. According to the display apparatus 200 of this example, it is possible to efficiently search the image important to the user from the images stored in a plurality of image databases 212 arranged in the network so as to display it.

The display apparatus 200 described referring to FIGS. 1, 2 and 3 may be a computer provided with a display, for example. The computer may have a memory for storing a program. In this case, this program makes the computer operate as the display unit 204 for displaying an image, and the importance calculation unit 202 for calculating the importance factor of the image, indicative of the importance of the image, based on the history in which the display unit 204 displayed the image. Moreover, the program makes the computer operate as the display apparatus 200 described referring to FIGS. 1, 2 and 3.

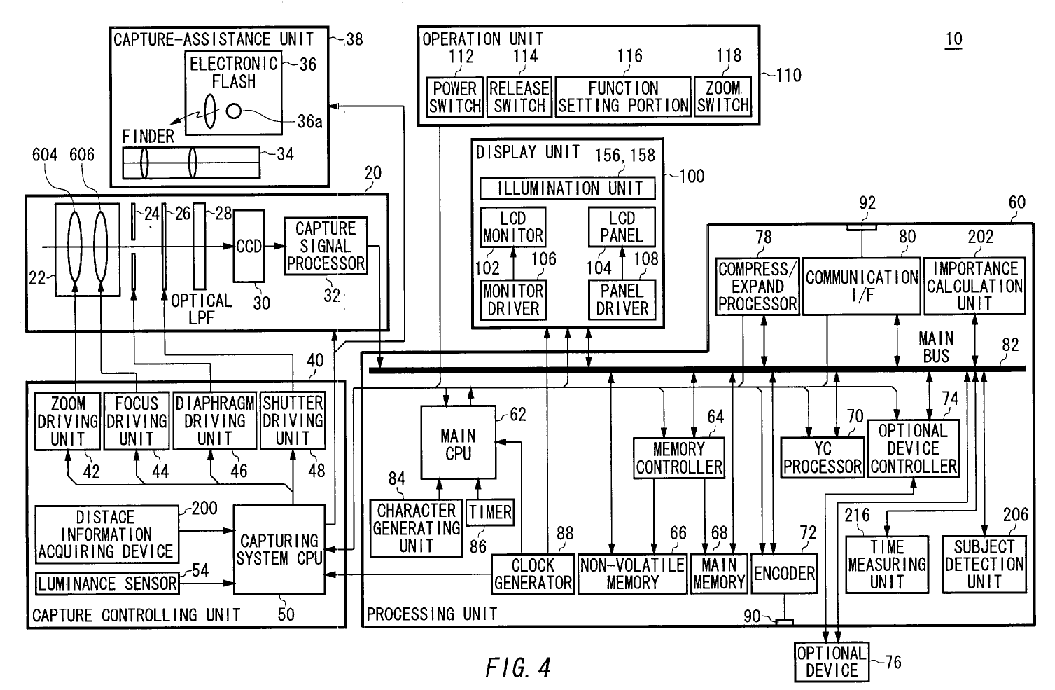

FIG. 4 is a block diagram of a capturing apparatus 10 according to the present invention. The capturing apparatus 10 is a digital camera, for example. In the following description, a case where the capturing apparatus 10 is the digital camera is described. The capturing apparatus 10 includes an image capturing unit 20, a capture-assistance unit 38, a capture controlling unit 40, a processing unit 60, a display unit 100 and an operation unit 110.

The image capturing unit 20 has mechanical members and electric members related to image capturing and image forming. The image capturing unit 20 includes an optical system 20 which receives an image and processes it, a diaphragm 24, a shutter 26, an optical LPF (low-pass filter) 28, a CCD (charge coupled device image sensor) 30 and a capture signal processor 32. The optical system 22 includes a focus lens 606 and a zoom lens 604. This structure allows an image of the subject to be formed on a light-receiving surface of the CCD 30. In accordance with the light amount of the subject image thus formed, the respective sensor elements (not shown) of the CCD 30 are electrically charged (in the following description, such electrical charges are referred to as “stored charges.” The stored charges are read into a shift register (not shown) by a read-gate pulse, and are then read as a voltage signal by a register transfer pulse sequentially.

In a case where the capturing apparatus 10 is a digital camera, the capturing apparatus 10 includes an electronic shutter function, in general. Thus, a mechanical shutter such as the shutter 26 is not necessary. In this case, in order to realize the electronic shutter function, the CCD 30 is provided with a shutter drain via a shutter gate. When the shutter gate is driven, the stored charges are drained out to the shutter drain. By controlling the shutter gate, a time period for storing the electric charges in the respective sensor elements, that is, a shutter speed can be controlled.

The voltage signal output from the CCD 30, that is, an analog signal, is subjected to color separation into R, G and B components by the capture signal processor 32, so that the white balance is adjusted. Then, the capture signal processor 32 performs gamma correction, performs A/D conversion (analog-to-digital conversion) for the R, G and B signals sequentially at necessary timings and outputs the image data obtained by the A/D conversion (hereinafter, simply referred to as “digital image data”), that is digital, to the processing unit 60.

The capture-assistance unit 38 includes a finder 34 and an electronic flash 36. The finder 34 includes an LCD (liquid crystal display) (not shown) therein. In this case, various information from a main CPU (central processing unit) 62, described later, or the like can be displayed in the finder 34. The electronic flash 36 works by light emission when energy stored in a capacitor (not shown) is supplied to a discharge tube 36a.

The capture controlling unit 40 includes a zoom driving unit 42, a focus driving unit 44, a diaphragm driving unit 46, a shutter driving unit 48, a capturing system CPU 50 that controls those components, a distance sensor 52 and a luminance sensor 54. The driving units such as the zoom driving unit 42 have associated driving means such as stepping motors, respectively. When a release switch 114 described later has been pressed, the distance sensor 52 measures a distance to the subject and the luminance sensor 54 measures the luminance of the subject. The measured distance data (hereinafter, simply referred to as “distance data”) and the measured luminance data (hereinafter, simply referred to as “luminance data”) are sent to the capturing system CPU 50. The capturing system CPU 50 controls the zoom driving unit 42 and the focus driving unit 44 so as to move the zoom lens 604 and the focus lens 606 of the optical system 22 in accordance with capturing information such as the zoom magnification specified by the user, thereby adjusting the zooming magnification and the focus.

The capturing system CPU 50 determines the F-number and the shutter speed based on an integrated value of the R, G and B digital signals of one image frame, that is, AE information. In accordance with the determined F number and shutter speed, the diaphragm driving unit 46 adjusts the size of an aperture of the diaphragm, and the shutter driving unit 48 performs opening/closing the shutter 26.

Moreover, the capturing system CPU 50 controls the light emission by the electronic flash 36 based on the luminance data and also adjusts the aperture size of the diaphragm 24. When the user instructs the capturing apparatus 10 to capture an image, the CCD 30 starts to be electrically charged. After the shutter period calculated from the luminance data has passed, the stored electric charges are output to the capture signal processor 32.

The processing unit 60 includes a main CPU 62 for controlling the entire capturing apparatus 10, especially the processing unit 60; a memory controller 64; a YC processor 70; an optional device controller 74; a compress/expand processor 78; a communication interface (I/F) 80; a time measuring unit 216; a subject detection unit 206; and an importance calculation unit 202 that are controlled by the main CPU 62. The main CPU 62 communicates with the capturing system CPU 50 by serial communication or the like. An operation clock of the main CPU 62 is supplied from a clock generator 88 that also supplies clocks having different frequencies to the capturing system CPU 50 and the display unit 100, respectively.

In addition to the main CPU 62, a character generator 84 and a timer 86 are provided in the processing unit 60. The timer 86 has the backing of a battery cell so that the timer 86 always counts the time and date. Based on the counted values, information regarding the captured date and time and other information related to the time are supplied to them a in CPU 62. The character generator 84 generates character information such as the captured date, a title of the captured image or the like. The thus generated character information is appropriately combined with the captured image.

The memory controller 64 controls a non-volatile memory 66 and a main memory 68. The non-volatile memory 66 includes an EEPROM (electrically erasable and programmable ROM), a FLASH memory or the like, and stores various data to be held even when the power of the capturing apparatus 10 is off, such as information set by the user and parameters set when the capturing apparatus 10 is shipped. The non-volatile memory 66 may store a boot program for the main CPU 62 or a system program, if necessary. On the other hand, the main memory 68 is formed by a relatively inexpensive memory having a larger capacity, such as a DRAM, in general. The main memory 68 has a function of a frame memory for storing data output from the image capturing unit 20, a function of a system memory for loading necessary programs, and a function of a working area. The non-volatile memory 66 and the main memory 68 communicate with the respective parts in the processing unit 60 via a main bus 82.

The YC processor 70 subjects the digital image data to YC conversion so as to generate a luminance signal Y and color difference signals B-Y and R-Y. The luminance signal and the color difference signals are temporarily stored in the main memory 68 by the memory controller 64. The compress/expand processor 78 successively reads the luminance signal and the color-difference signals from the main memory 68 and compresses the read signals. The resultant data (hereinafter, simply referred to as “compressed data”) is written onto a memory card, that is a kind of an optional device 76, via the optional device controller 74.

The processing unit 60 further includes an encoder 72. The encoder 72 inputs the luminance signal and the color difference signals, converts these input signals into a video signal (NTSC or PAL signal) and then outputs the video signal from a video output terminal 90. In a case of generating the video signal from the data stored in the optional device 76, the data is first supplied to the compress/expand processor 78 via the optional device controller 74, and is then subjected to a necessary expansion operation in the compress/expand processor 78. Finally, the expanded data is converted into the video signal by the encoder 72.

The optional device controller 74 performs generation of a signal or signals required by the main bus 82 and the optional device 76, logical transform, or voltage conversion in accordance with the specification of signals accepted by the optional device 76 and the bus-specification of the main bus 82. The capturing apparatus 10 may support a device other than the aforementioned memory card, for example, a standard I/O card conforming to PCMCIA, as the optional device 76. In this case, the optional device controller 74 may be formed by an LSI for controlling a bus for PCMCIA.

The communication I/F 80 controls protocol conversion or the like in accordance with the communication specification supported by the capturing apparatus 10, such as USB, RS-232C or Ethernet (registered trademark). The communication I/F 80 includes a driver IC, if necessary, and communicates with an external apparatus including a network via a connector 92. In addition, the capturing apparatus 10 may be configured to allow data communication with an external apparatus such as a printer, a karaoke (sing-along machine), or a game player via a special I/F, other than the above-mentioned standard specification.

The time measuring unit 216 measures a capture-preparation time for capturing the image. For example, the time measuring unit 216 measures a time period in which the capture controlling unit 40 controls the capturing unit 20 in order to capture the image. The time measuring unit 216 may measure a time period in which the user is in continuous contact with the release switch 114 when the user captures the image.

The subject detection unit 206 may have the same or similar function and structure as/to that described referring to FIG. 2. The subject detection unit 206 detects the subject of the image captured by the capturing unit 20. The importance calculation unit 202 may have the same or similar function and structure as/to that described referring to FIG. 2. The importance calculation unit 202 calculates the importance factor of the image indicative of the importance of that image based on the capture-preparation time measured by the time measuring unit 216.

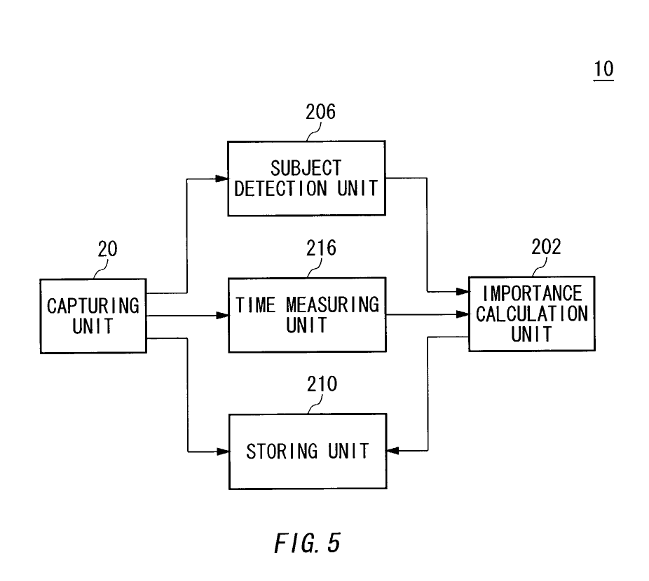

The time measuring unit 216, the subject detection unit 206, and the importance calculation unit 202 operate based on at least one program stored in the non-volatile memory 66 or the main memory 68. Moreover, the memory controller 64 receives, from an external device via the communication I/F 80, a program for making the image processing unit 220 operate and store it in the non-volatile memory 66. Also, the memory controller 64 receives the program from the optional device 76 and store it in the non-volatile memory 66. The program stored in the non-volatile memory 66 or main memory 68 makes the capturing apparatus 10 operate as the capturing unit 20, the time measuring unit 216, the subject detection unit 206 and the importance calculation unit 202 described above, for example. In addition, the program makes a processing apparatus such as a computer, for example, operate to have the aforementioned functions. The processes the program instructs the capturing apparatus 10 to perform are the same or similar to the functions and operations as/to those of the capturing unit 20, the subject detection unit 206, the time measuring unit 216, the storing unit 210, and the importance calculation unit 202 described later, referring to FIG. 5.

The display unit 100 includes a liquid crystal monitor 102 and an LCD panel 104 that are respectively controlled by a monitor driver 106 and a panel driver 108 both of which are an LCD driver. The liquid crystal monitor 102, that has a size of about 2 inches, for example, is provided on the back face of the digital camera, and displays a current operation mode such as a capture mode or a playback mode, the magnification of the image capturing or the playback, the residual amount of the battery cell, the date and time, a screen for setting modes, an image of the subject, or the like. The LCD panel 104 is a small monochrome LCD, for example, and is provided on the top face of the camera. The LCD panel 104 simply displays information such as the image quality (FINE/NORMAL/BASIC, for example), ON/OFF of the electronic flash, the number of images normally capturable, the number of pixels, and the battery capacity or the like.

In the present embodiment, the display unit 100 further includes illumination units 156 and 158. The illumination units 156 and 158 give illumination by using a light source of the liquid crystal monitor 102. Please note that the illumination units 156 and 158 may be provided in the capturing unit 10 as separate components from the liquid crystal monitor 102, which have light sources of their own.

The operation unit 110 includes mechanisms and electric members required for the user to set or instruct the operation and the operation mode of the capturing apparatus 10 to the capturing apparatus 10. A power switch 112 determines whether or not the power of the capturing apparatus 10 is turned on/off. The release switch 114 has a two-step structure allowing half-pressing and complete-pressing of it. For example, when the release switch 114 is half-pressed, AF and AE are locked. Then, the release switch 114 is completely pressed, a shot image is taken into the capturing apparatus 10 and is recorded in the main memory 68 and/or the optional device 76 after necessary signal processing and data compression and the like are performed. The operation unit 110 may receive settings set by a switch other than the above-mentioned switches, such as a rotary mode dial or a cross key. These switches as a whole are called as a function setting portion 116 in FIG. 2. The operations or functions that can be set by the operation unit 110 include “file format”, “special effect”, “print”, “determine/save”, and “change display”, for example. A zoom switch 118 determines the zooming magnification.

A main operation of the capturing apparatus 10 having the aforementioned structure is described below. First, when a power switch 112 of the capturing apparatus 10 has been turned on, a main power is turned on and electric power is supplied to the respective parts in the camera. The main CPU 62 then determines whether or not the capturing apparatus 10 is in a capture mode or a playback mode by reading the status of a function setting portion 116.

Next, the main CPU 62 monitors whether or not the release switch 114 is half-pressed. In a case where a stand is closed, when detecting the half-pressing of the release switch 114, the main CPU 62 acquires the luminance data and the distance data from the luminance sensor 54 and the distance sensor 52, respectively. The capture controlling unit 40 then operates based on the acquired data, so that the focus of the optical system 22, the aperture size and the like are adjusted. The main CPU 62 acquires the luminance data only from the luminance sensor 54 when detecting the half-pressing of the release switch 114. The capture controlling unit 40 adjusts the aperture size of the optical system 22.

After the adjustment is finished, the main CPU 62 makes the LCD monitor 102 display characters “stand-by”, thereby notifying the user of the finish of the adjustment. Then, the main CPU 62 monitors whether or not the release switch 114 has been completely pressed. When the release switch 114 is completely pressed, the shutter 26 is closed after a predetermined shutter time has passed, and the stored charges in the CCD 30 are drained out to the capture signal processor 32. The digital image data generated by the process by the capture signal processor 32 is output to the main bus 82.

The digital image data is stored in the main memory 68 temporarily, and is then processed by the YC processor 70 and the compress/expand processor 78. The processed digital image data is recorded in the optional device 76 via the optional device controller 74. The recorded image is displayed on the LCD monitor 102 for a while, while the image is kept still, thereby the user can confirm the captured image. Thus, a sequence of the capturing operation has been finished.

On the other hand, in a case where the capturing apparatus 10 is in the playback mode, the main CPU 62 reads out the last captured image from the main memory 68 via the memory controller 64 and makes the LCD monitor 102 of the display unit 100 display the thus read image. In this state, when the user sets “forward” or “backward” in the function setting portion 116, the image captured before and after the currently displayed image is read and displayed on the LCD monitor 102. The time measuring unit 216 measures a capture-preparation time of the image captured by the capturing unit 20. The subject detection unit 206 detects the subject of the image captured by the capturing unit 20. The importance calculation unit 202 calculates the importance factor of the image captured by the capturing unit 20 based on the capture-preparation time and/or the subject of that image. The main memory 68 stores the image captured by the capturing unit 20 and the importance factor calculated by the importance calculation unit 202 so as to correspond to each other. Next, the function of the calculation of the importance of the image is described with referring to a block diagram.

FIG. 5 is a block diagram showing an exemplary structure of the capturing apparatus 10. The capturing apparatus 10 includes the capturing unit 20, the subject detection unit 206, the time measuring unit 216, the storing unit 210 and the importance calculation unit 202. The components in FIG. 5 labeled with the same reference numerals as those in FIG. 4 may have the same or similar as/to those described referring to FIG. 4.

The capturing unit 20 captures an image of the subject. The capturing unit 20 includes a zoom lens and a focus lens, for example. The zoom driving unit 42 (see FIG. 4) and the focus driving unit 44 (see FIG. 4) control the zoom lens and the focus lens, respectively.

The time measuring unit 216 may measure the capture-preparation time for capturing the image based on the driving time of the zoom lens in the capturing operation for that image. For example, when the image is to be captured, the time measuring unit 216 may measure the capture-preparation time of that image based on the length of the time period during which the zoom driving unit 42 drives the zoom lens. In another example, the time measuring unit 216 may measure the capture-preparation time based on the length of the time from the start of the driving of the zoom lens in the image capturing operation to a time at which the image has been captured.

Moreover, the time measuring unit 216 may measure the capture-preparation time for capturing the image based on the driving time of the focus lens in the image capturing operation. For example, when the image is to be captured, the time measuring unit 216 may measure the capture-preparation time of that image based on the length of the time period during which the focus driving unit 44 drives the focus lens. Alternatively, the time measuring unit 216 may measure the capture-preparation time based on the length of the time from the start of the driving of the focus lens in the image capturing operation to a time at which the capturing unit 20 has captured the image.

The time measuring unit 216 may include a determination unit operable to determine whether or not the user is in contact with the release switch 114 (see FIG. 4). In this case, the time measuring unit 216 may measure the capture-preparation time of the image based on the length of the time period during which the user is in contact with the release switch in the image capturing operation for that image. Alternatively, the time measuring unit 216 may measure the capture-preparation time of the image based on the length of the time period during which the user is in continuous contact with the release switch 114 until the user presses the release switch 114 in order to capture that image. Moreover, the time measuring unit 216 may measure the capture-preparation time of the image based on the length of the time period from a time at which the release switch 114 is half-pressed to a time at which the release switch 114 is completely pressed.

The importance calculation unit 202 calculates the importance factor of the image based on the capture-preparation time for that image measured by the time measuring unit 216. That is, the importance calculation unit 202 calculates for the image for which the capture-preparation time is longer the importance factor that indicates the image is more important.

The subject detection unit 206 has the same or similar function and structure as that described referring to FIG. 2. The subject detection unit 202 detects a predetermined subject. As described referring to FIG. 2, the importance calculation unit 202 may calculate the importance factor of the image further based on the subject in that image. Moreover, the subject detection unit 206 may detect out the images stored in the storing unit 210 which includes the similar subject. When there are many images detected by the detection unit 206, then the importance calculation unit 202 may provide the greater importance factor indicating the higher importance to the image.

The storing unit 210 stores the importance factor calculated by the importance calculation unit 202 so as to correspond to the image. According to the capturing apparatus 10 described in this example, it is possible to easily calculate the importance of the captured image to the user.

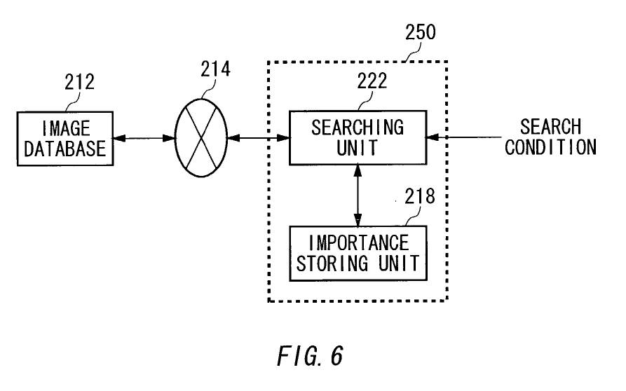

FIG. 6 is a block diagram showing an exemplary structure of an image searching apparatus 250 according to the present invention. The image searching apparatus 250 includes a searching unit 222 and an importance storing unit 218, for example. The image searching apparatus 250 conducts a search for desired images from a plurality of image database 212. In this example, a case where the image searching apparatus 250 is connected to the image database 212 via the network 214 is described. In an alternative example, the image searching apparatus 250 may include the storing unit 210 described referring to FIG. 2 and search the image in the storing unit 210.

The importance storing unit 218 stores the importance factor indicating the importance of each image stored in the image database 212. In this example, the importance storing unit 218 may store the importance factor described referring to FIGS. 1-5. The searching unit 222 searches a desired image in the image database 212 based on the importance factors stored from the images stored in the importance storing unit 218. For example, the searching unit 222 receives a search condition for searching the desired image supplied thereto and searches at least one image having the importance factor greater than a predetermined value. The searching unit 222 may include the same or similar function and structure as/to the image searching apparatus 208 described referring to FIG. 2. Moreover, the importance storing unit 218 may store the importance factor of each image based on the capture-preparation time when that image is captured.

Although the importance storing unit 218 stores the importance factors of the images in this example, the image database 212 may store the images and the importance factors corresponding to the respective images in an alternative example. In this case, the searching unit 222 searches the image based on the importance factors stored in the image database 212.

The image searching apparatus 250 may further include a storing unit for storing the image searched by the searching unit 222. This storing unit may have the same or similar function and structure as/to the storing unit 210 described referring to FIG. 2. Moreover, the image searching apparatus 250 may further include a display for displaying the image searched by the searching unit 222. The display may have the same or similar function and structure as/to the display unit 204 described referring to FIG. 2.

According to the image searching apparatus 250 in this example, it is possible to efficiently search an image which is important to the user, an image in which the user is interested or the like. The image searching apparatus 250 described in this example may be a computer, for example. The computer includes a memory for storing a program. The program may make the computer, that is the image searching apparatus 250, operate as the importance storing unit 218 for storing the importance factor indicative of the corresponding image and the searching unit 222 for searching a desired image in the image database 212. In addition, the display apparatus 200 described referring to FIGS. 1-3 may include the image searching apparatus 250 described referring to FIG. 6 as the image searching apparatus 208.

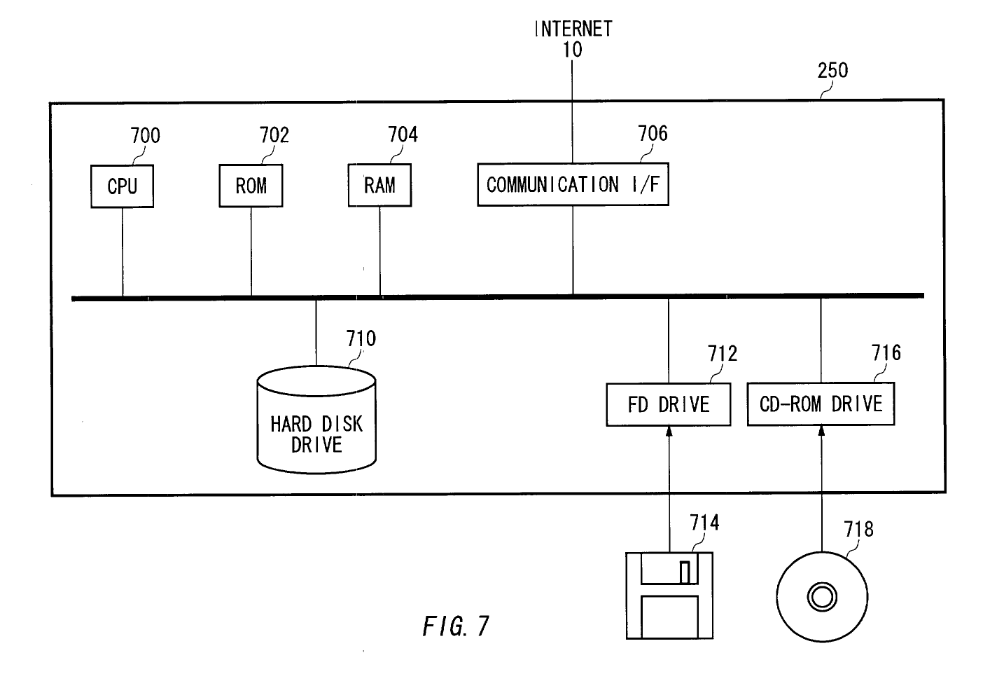

FIG. 7 shows an exemplary hardware configuration of the image searching apparatus 250. The image searching apparatus 250 includes: a CPU 700; a ROM 702; a RAM 704; a communication interface 706; a hard disk drive 710; a flexible disk drive 712; and a CD-ROM drive 716. The CPU 700 operates based on at least one program stored in the ROM 702 and RAM 704. The communication interface 706 communicates with the outside via the Internet 10. In the present example, the communication interface 706 communicates with the image database 212 (see FIG. 6). The hard disk drive 710 serving as a storage device stores the program based on which the CPU 700 operates. The program is the same or similar as/to the program described referring to FIG. 6. In this example, the hard disk drive 710 may store the importance of each image stored in the image database 212, like the importance storing unit 218 described referring to FIG. 6.

The flexible disk drive 712 reads data or program from a flexible disk 714 to provide the read data or program to the CPU 700. The CD-ROM drive 716 reads data or program from a CD-ROM 718 to provide the read data or program to the CPU 700. The communication interface 706 is connected to the Internet 10 and performs data transmission and receiving.

The program to be executed by the CPU 700 is provided to the user while being stored in a recording medium such as the flexible disk 714 or the CD-ROM 718. The program stored in the recording medium may be compressed or not-compressed. The program is read from the recording medium to be installed into the hard disk drive 710. Then, the program is read into the RAM 704 and is executed by the CPU 700.

The program provided while being stored in the recording medium, that is the program to be installed into the hard disk drive 710, functionally includes the same or similar functional structure as/to the program described referring to FIG. 6. Operations that are to be executed by the CPU 700 in accordance with instructions by the program to the CPU 700 may be the same or similar as/to the operations of the respective components in the respective examples of the present invention.

A part or all of the functions of the display apparatus 200, the capturing apparatus 10, and the image searching apparatus 250 according to all the embodiment described in the present application can be stored in the flexible disk 714 or the CD-ROM 718 that is shown in FIG. 6 as an example of the recording medium.

These programs may be read directly into the RAM from the recording medium so as to be executed. Alternatively, these programs maybe read into the RAM so as to be executed, after being installed into the hard disk drive from the recording medium. Moreover, the above-mentioned programs may be stored in a single recording medium or a plurality of recording media. Furthermore, the modules stored in the recording medium may provide the respective functions by cooperation with an operating system. For example, the modules may ask the operating system to perform a part or all the functions of the modules and provide the function in accordance with a response from the operating system.

As the recording medium, other than the flexible disk and the CD-ROM, an optical recording medium such as a DVD or a PD, a magneto-optical recording medium such as an MD, a tape-like medium, a magnetic recording medium, or a semiconductor memory such as an IC card or a miniature card can be used. Moreover, a storage device such as a hard disk or a RAM provided in a server system connected to an exclusive communication network or the Internet may be used as the recording medium, so that the program can be provided to the image searching apparatus 250 through a communication network.

Such a recording medium is used only for manufacturing the image searching apparatus 250 and it is therefore apparent that manufacturing, selling such a recording medium on business constitutes infringement of a right based on the present application.

As is apparent from the above, according to the display apparatus 200, the capturing apparatus 10, the image searching apparatus 250 and the program of the present invention, it is possible to display and/or search the image based on the importance to the user.

Although the present invention has been described by way of exemplary embodiments, it should be understood that those skilled in the art might make many changes and substitutions without departing from the spirit and the scope of the present invention which is defined only by the appended claims.

What is claimed is:

1. A display apparatus for displaying an image, comprising:
a display unit operable to display said image; and
an importance calculation unit operable to calculate an importance factor indicative of importance of said image based on a history in which said display unit has displayed said image before.

2. A display apparatus as claimed in claim 1, wherein said importance calculation unit calculates said importance factor of said image based on a number of times said display unit displayed said image.

3. A display apparatus as claimed in claim 1, wherein said importance calculation unit calculates said importance factor of said image based on a time period in which said display unit displayed said image.

4. A display apparatus as claimed in claim 1, wherein said display unit includes an enlarging unit operable to enlarge all or a part of said image when displaying said image, and
said importance calculation unit calculates said importance factor of said image based on whether or not said display unit enlarged said image when displaying said image.

5. A display apparatus as claimed in claim 2, wherein said importance calculation unit calculates said importance factor of said image further based on a subject in said image.

6. A display apparatus as claimed in claim 5, wherein said importance calculation unit calculates said importance factor of said image based on whether or not a person is captured in said image.

7. A display apparatus as claimed in claim 5, further comprising a subject detection unit operable to detect a predetermined subject, wherein
said importance calculation unit calculates said importance factor of said image based on a result of detection by said subject detection unit whether or not said predetermined subject is captured.

8. A display apparatus as claimed in claim 3, wherein said importance calculation unit calculates said importance factor of said image further based on a subject in said image.

9. A display apparatus as claimed in claim 8, wherein said importance calculation unit calculates said importance factor of said image based on whether or not a person is captured in said image.

10. A display apparatus as claimed in claim 8, further comprising a subject detection unit operable to detect a predetermined subject, wherein said importance calculation unit calculates said importance factor of said image based on a result of detection by said subject detection unit whether or not said predetermined subject is captured.

11. A display apparatus as claimed in claim 4, wherein said importance calculation unit calculates said importance factor of said image further based on a subject in said image.

12. A display apparatus as claimed in claim 11, wherein said importance calculation unit calculates said importance factor of said image based on whether or not a person is captured in said image.

13. A display apparatus as claimed in claim 11, further comprising a subject detection unit operable to detect a predetermined subject, wherein said importance calculation unit calculates said importance factor of said image based on a result of detection by said subject detection unit whether or not said predetermined subject is captured.

14. A display apparatus as claimed in claim 1, further comprising a storing unit operable to store a plurality of images and importance factors respectively calculated for said plurality of images by said importance calculation unit in such a manner that said plurality of images and said importance factors correspond to each other, wherein
said display unit displays at least one of said plurality of images stored in said storing unit.

15. A display apparatus as claimed in claim 14, wherein, in a case where said display unit enlarged a part of said image when displaying said image, said storing unit stores said part of said image enlarged by said display unit to correspond to said image.

16. A display apparatus as claimed in claim 14, wherein said display unit displays at least one of said plurality of image based on said importance factors.

17. A display apparatus as claimed in claim 16, wherein said display unit displays said plurality of images in an order from an image of the highest importance factor.

18. A display apparatus as claimed in claim 1, wherein said display apparatus is connected to an image database storing a plurality of images via a network, and
said display unit displays at least one of said plurality of images stored in said image database.

19. A display apparatus as claimed in claim 18, further comprising a storing unit operable to store said image displayed by said display unit and said importance factor corresponding to said image.

20. A display apparatus as claimed in claim 18, further comprising a storing unit operable to an identification signal of said image in said network, displayed by said display unit, and said importance factor corresponding to said image.

21. A display apparatus as claimed in claim 14, further storing an image searching apparatus operable to search a desired one of said plurality of images stored in said storing unit based on said importance factors stored by said storing unit.

22. A display apparatus as claimed in claim 18, further storing an image searching apparatus operable to search a desired one of said plurality of images stored in said image database based on said importance factors stored by said storing unit.

23. A display apparatus as claimed in claim 22, wherein said storing unit stores said image searched by said image searching apparatus.

24. A display apparatus as claimed in claim 21, wherein said image searching apparatus receives a search condition for searching said desired image supplied thereto, and searches said desired image based on said search condition.

25. A display apparatus as claimed in claim 24, wherein said image searching apparatus searches said desired image from images each having said importance factor greater than a predetermined value.

26. A display apparatus as claimed in claim 22, wherein said image searching apparatus receives a search condition for searching said desired image supplied thereto, and searches said desired image based on said search condition.

27. A display apparatus as claimed in claim 26, wherein said image searching apparatus searches said desired image from images each having said importance factor greater than a predetermined value.

28. A display apparatus as claimed in claim 21, wherein said image searching apparatus searches an image similar to said image, that has said importance factor greater than a predetermined value.

29. A display apparatus as claimed in claim 22, wherein said image searching apparatus searches an image similar to said image, that has said importance factor greater than a predetermined value.

30. A program, for use with a display apparatus, for making a display apparatus calculate importance of an image, wherein said program makes said display apparatus operate as:
a display unit operable to display said image; and
an importance calculation unit operable to calculate an importance factor indicative of said importance of said image based on a history in which said display unit displayed said image.

31. A capturing apparatus for capturing an image, comprising:
a capturing unit operable to capture said image of a subject;
a time measuring unit operable to measure a capture-preparation time for capturing said image; and
an importance calculation unit operable to calculate an importance factor indicative of importance of said image based on said capture-preparation time measured by said time measuring unit.

32. A capturing apparatus as claimed in claim 31, further comprising a storing unit operable to store said importance factor calculated by said importance calculation unit to correspond to said image.

33. A capturing apparatus as claimed in claim 31, wherein said capturing unit has a zoom lens, and
said time measuring unit measures said capture-preparation time based on a driving time of said zoom lens during a capture of said image.

34. A capturing apparatus as claimed in claim 33, wherein said time measuring unit measures said capture-preparation time based on a time from a driving start of said zoom lens during said capture of said image to a time at which said capturing unit has captured said image.

35. A capturing apparatus as claimed in claim 31, wherein said capturing unit has a focus lens, and
said time measuring unit measures said capture-preparation time based on a driving time of said focus lens during a capture of said image.

36. A capturing apparatus as claimed in claim 35, wherein said time measuring unit measures said capture-preparation time based on a time from a driving start of said focus lens during said capture of said image to a time at which said capturing unit has captured said image.

37. A capturing apparatus as claimed in claim 31, further comprising a release switch operable to control a capturing timing of said capturing unit, wherein
said time measuring unit includes a determining unit operable to determine whether or not a user is in contact with said release switch, and measures said capture-preparation time based on a time during which said user is in contact with said release switch.

38. A capturing apparatus as claimed in claim 37, wherein said time measuring unit measures said capture-preparation time based on a time during which said user is in continuous contact with said release switch until said user presses said release switch.

39. A capturing apparatus as claimed in claim 33, wherein said importance calculation unit calculates said importance factor of said image further based on a subject in said image.

40. A capturing apparatus as claimed in claim 39, wherein said importance calculation unit calculates said importance factor of said image based on whether or not a person is captured in said image.

41. A capturing apparatus as claimed in claim 39, further comprising a subject detection unit operable to detect a predetermined subject, wherein
said importance calculation unit calculates said importance factor of said image based on whether or not said predetermined subject is captured in said image.

42. A capturing apparatus as claimed in claim 35, wherein said importance calculation unit calculates said importance factor of said image further based on a subject in said image.

43. A capturing apparatus as claimed in claim 42, wherein said importance calculation unit calculates said importance factor of said image based on whether or not a person is captured in said image.

44. A capturing apparatus as claimed in claim 42, further comprising a subject detection unit operable to detect a predetermined subject, wherein
said importance calculation unit calculates said importance factor of said image based on whether or not said predetermined subject is captured in said image.

45. A capturing apparatus as claimed in claim 37, wherein said importance calculation unit calculates said importance factor of said image further based on a subject in said image.

46. A capturing apparatus as claimed in claim 45, wherein said importance calculation unit calculates said importance factor of said image based on whether or not a person is captured in said image.

47. A capturing apparatus as claimed in claim 45, further comprising a subject detection unit operable to detect a predetermined subject, wherein
said importance calculation unit calculates said importance factor of said image based on whether or not said predetermined subject is captured in said image.

48. A program, for use with a capturing apparatus, for making said capturing apparatus calculate importance of an image, wherein said program makes said capturing apparatus operate as:
a capturing unit operable to capture said image of a subject;
a time measuring unit operable to measure a capture-preparation time for capturing said image; and
an importance calculation unit operable to calculate an importance factor indicative of said importance of said image based on said capture-preparation time measured by said time measuring unit.

49. An image searching apparatus for searching a desired image from a plurality of images stored in an image database, comprising:
an importance storing unit operable to store an importance factor indicative of importance of each of said images; and
a searching unit operable to search said desired image in said image database based on said importance factor.

50. An image searching apparatus as claimed in claim 49, wherein said importance storing unit stores said importance factor for each image based on a time-preparation time when said image is captured.

51. A program, for use with an image searching apparatus, for making said image searching apparatus search a desired image from a plurality of images stored in an image database, wherein said program makes said image searching apparatus operate as:
an importance storing unit operable to store an importance factor of each image indicative of importance of said image; and
a searching unit operable to search said desired image in said image database.
